(19) United States
(12) Patent Application Publication
(10) Pub. No.: US 2022/0046971 A1
(43) Pub. Date: Feb. 17, 2022

(54) EDIBLE PRODUCTS

(71) Applicant: JELLY DROPS LIMITED, Saffron Walden, Essex (GB)

(72) Inventors: Michael Lewis HORNBY, Saffron Walden, Essex (GB); Claudia ARNOLD, Saffron Walden, Essex (GB); Nicholas Dorset HOOTON, Saffron Walden, Essex (GB)

(21) Appl. No.: 17/413,507

(22) PCT Filed: Dec. 23, 2019
(86) PCT No.: PCT/GB2019/053686

§ 371 Date: Jun. 11, 2021

(30) Foreign Application Priority Data
Dec. 21, 2018 (GB) 1821157.3
Dec. 3, 2019 (GB) 1917666.8
Dec. 3, 2019 (GB) 1917667.6

(51) Int. Cl. A23L 33/125; A23L 29/281; A23L 29/256; A23P 10/30; A23G 3/42; A23G 3/54

(52) U.S. Cl. CPC A23L 33/125; A23L 29/284; A23L 29/256; A23V 2002/00; A23G 3/42; A23G 3/545; A23P 10/30

(57) ABSTRACT

The present invention relates to edible products, suitable for use as confectionery and having therapeutic uses. We describe a composition for the preparation of an edible product, the composition comprising 0.2 wt. % to 3 wt. % of at least one polysaccharide gelling agent, the balance being water. In preferred composition, the at least one polysaccharide is at least one of agar, pectin, locust bean gum, gellan gum and carrageenan. The compositions preferably comprise 0.5 wt. % to 2.00 wt. % agar and 0.05 to 1.0 wt. % of a galactomannan polysaccharide; the balance being water; preferably wherein the galactomannan polysaccharide is present in an amount of from 10% to 40% the amount of agar.

The present invention relates to edible products. In particular, it relates to edible products suitable for use as confectionery and having therapeutic uses. In particular, it relates to products of the type referred to as gummies and jellies and to compositions and methods for the preparation thereof; and to their use as confectionery and in therapy, in particular in hydration therapies.

Dementia is the leading cause of death in the UK and the number of people globally with dementia is set to treble to at least 150 million by 2050.

It is very easy for people with dementia to become dehydrated and their dehydration can have a number of causes or triggers. Many no longer have an awareness of thirst, do not equate drinking with quenching thirst, forget what a cup is for (memory), do not recognise cups for what they are (agnosia), lack the muscular dexterity to use cups (coordination), lack the “muscle memory” to use cups (procedural memory), or lack the ability to plan to use a cup (executive function).

Sources of hydration in liquid format can be difficult for people with dementia to engage with. They are often spilt and can easily be inhaled, causing choking. It can also be very time consuming for carers to keep someone with dementia sufficiently hydrated. Care homes often struggle to fulfil this requirement. The result can be an accelerated decline in residents' conditions that reduces quality of life and exacerbates other care requirements, in turn increasing hospital admissions and strain on the health service providers, such as the NHS.

The cost of dementia to the UK is currently estimated to be £26 billion a year, equivalent to £32,250 per person with dementia per year.

Water is needed in the body for a wide range of uses including regulating temperature (through sweating), maintaining blood pressure and eliminating bodily waste, as well as a host of cell reactions. Even mild dehydration can have an effect on people, causing tiredness, headaches and a lack of concentration.

Urinary tract infections (UTIs) are a type of infection common among older people. If a person with a memory impairment or dementia has a UTI, this can cause sudden and severe confusion referred to as delirium. This often leads to hospital admission to be treated with antibiotics and can lead to kidney damage and blood poisoning, which can be fatal.

For people with dementia, the symptoms of dehydration are often mistakenly attributed to their underlying condition, meaning it can easily go unnoticed until it becomes life-threatening.

Often, in a care home setting, there are only short windows of opportunity where a resident will allow a carer to feed them a drink. This results in relatively large volumes of liquid being administered at once. For elderly people with poor kidney function this often results in most of the fluid passing straight through their system, reducing the hydration delivered and increasing urine output. Hydration is related to the amount of fluid absorbed, not the amount ingested.

Given aging societies worldwide, a solution is needed to improve hydration, whilst simultaneously reducing care requirements. The present invention provides hydrating products that enable people with dementia to hydrate more often and independently. It with this in mind that the present invention has been devised.

A common trait of people with dementia is that they enjoy eating sweets. It has been observed that many become excited and enthusiastic when presented with this food type.

The finger food format is more easily engaged with and people with dementia intuitively know how to interact with it.

In its broadest aspect, the present invention provides an edible product containing a large proportion of water within a solid or semi-solid matrix. Suitably, the matrix is formed by a hydrocolloid or hydrocolloidal mixture.

Consequently, the edible products of the present invention present a person with dementia with a large volume of water in a solid format. This is easier for the person to pick up and engage with compared with liquid or viscous sources of hydration. This is especially the case for people with limited dexterity and coordination. Additionally, by containing the water within a matrix, the product does not ‘pop’, releasing the water suddenly when chewed. For people with reduced cognitive abilities, this may be unexpected and can lead to choking.

Gummies and jellies are a class of confectionery based on using a hydrocolloid to stabilise a bulk sweetener, acting as a bulking agent for the confectionery, to produce a gel-like product having a moisture content of up to about 10-20 wt. %, depending upon the desired firmness of the confectionery product. Lower water content products have a firmer texture. The hydrocolloids crosslink during the heating step of the manufacturing process to form a network structure within which the molecules of the bulk sweetener become trapped to form a semi-solid or gelled structure.

Generally, the bulk sweetener in a gummy or jelly confection is present in an amount of 70-85 wt. % based on the total weight of the gummy or jelly formulation prior to heating. Typically, the bulk sweetener is a mixture of sucrose and glucose syrup. Glucose syrup typically forms 50-60 wt. % of the bulk sweetener mixture, the balance being sucrose. In view of the calorific content of sucrose and glucose, alternative bulk sweeteners have been used to provide reduced-sugar or sugar-free products. Polyols such as maltitol, sorbitol, mannitol, maltitol, isomalt and allulose have been used or proposed. However, overconsumption of polyols can lead to gastrointestinal symptoms, such as diarrhoea, in some individuals. Additionally, whilst polyols are low in calories, they can be converted to glucose in the liver. Accordingly, the use of polyols as bulking agents is far from ideal.

The most common hydrocolloids used are gelatine, starches and pectin. Other hydrocolloids such as agar, gum Arabic and carrageenan, amongst others, are often used in mixtures with other hydrocolloids to modify the visual and textural characteristics of the confectionery product.

Gelatine is perhaps the most common hydrocolloid used in gummies and jellies and is a protein derived from collagen, primarily bovine or porcine in origin. Gelatine is typically used in an amount of about 5 to 10% by weight based on the total of the ingredients for the formulation. Gelatine is obviously unsuitable for consumers on vegetarian or vegan diets.

Pectin is a galactomannan hydrocolloid obtained from fruit, typically by extraction of citrus peels or apple pomace. Pectin allows the formation of firm gels at lower concentrations than gelatine, typically at around 1-2 wt. %.

Agar (also referred to as agar agar) is a galactose polymer extracted from red algae which forms a firm gel at low concentrations of around 0.1 to 0.5 wt. %.

The process for the manufacture of gummy or jelly confectionery varies depending upon the hydrocolloid or mixture of hydrocolloids used and may involve mixing the bulk sweetener and the hydrocolloid or mixture of hydrocolloids, together with any additional ingredients such as flavourings, colourings and acids, followed by heating, with stirring, and then cooling to the appropriate setting temperature for the hydrocolloid, and for a period sufficient to achieve the required water content. In recipes where the hydrocolloid is gelatine, typically a gelatine solution is added to a cooled sugar syrup.

The cooked composition is then formed into the final product shape. Typical processes include: i) pouring the fluid mass onto a slab, allowing the mixture to cool and then cutting into the desired shape; and ii) depositing into moulds, typically starch moulds.

Following forming, the gummies or jellies are subjected to a curing or stoving process in which excess moisture is removed so that the products dry to their final desired water content of up to about 20 wt. %. The stoving conditions are important to the satisfactory characteristics of the final product and typically involve maintenance of appropriate temperatures, relative humidity and air flow, to promote adequate drying at a satisfactory rate. A relative humidity of below about 50% is required. The stoving temperature is dependent upon the gelling agent and is typically 24-35° C. for gelatine, to avoid melting the gelatine, 32-43° C. for agar and 49-66° C. for pectin gels. Even with optimised environmental conditions, residence times of 8-24 hours are required.

A report by Carbon Trust in 2011 (Industrial Energy Efficiency Accelerator—Guide to the confectionery stoving sector—Report CTG035) estimated that about 25% of the energy consumption of the sugar confectionery sector, and the associated costs of that energy consumption, were attributable to the stoving process. The report proposed various solutions for greater energy efficiencies for the stoving stage of the manufacturing process.

Other researchers have proposed changes to the formulation of gummy and jelly confectionery with the aim of avoiding the need for any stoving step.

For example, WO 2018/134365 proposes high gelatine content formulations, having a gelatine content of up to 15 wt. % and optionally also containing pectin, in which the gelatine preferably has a bloom value in the range of 225 to 250; and moulding the confectionery in silicone moulds. By using high bloom gelatine, the inventors claim that no stoving step is required and confectionery products acquire a finished state after 25 minutes of cooling to set.

U.S. Pat. No. 6,419,979 hypothesises a modified process in which the confectionery formulation is subjected to moisture-reducing steps prior to moulding. The formulation is applied as a film to a first hot surface of a scrape evaporator to remove moisture from the formulation to an intermediate water content. The film is then scraped from the first hot surface and allowed to flow to a second heated surface which removes further moisture from the slurry until a predetermined final total solids content is achieved. The concentrated slurry is then removed from the second surface and formed into a confectionery product. Since the product is moulded at its final water content level, a specific stoving step is not essential. However, it will be appreciated that this considerably complicates the manufacturing process, requiring considerable additional expenditure in providing a multiple stage scrape evaporator. Whilst solving one problem, the proposed process creates its own issues.

Accordingly, there is a need for an alternative approach to addressing the problems associated with gummy and jelly confectionery manufacture. It is with these issues in mind that the present invention has been devised.

We have determined that by using a hydrocolloid mixture of agar and a galactomannan polysaccharide, preferably locust bean gum, we can prepare gummy and jelly products in which the bulking agent is water. Compared with known gummies and jellies, which typically have a final water content of no greater than 20 wt. %, our products have a water content of the order of 90 wt. % or more. Such a surprisingly high water content makes our products exceptionally useful as hydration products, for use in hydration therapies, as described above.

Furthermore, since we can avoid the requirement for bulk sweeteners, our products can satisfy the regulatory requirements to be defined as being sugar-free and as tooth-friendly.

Additionally, we have determined that products produced using this mixture can be prepared without the need for a conventional stoving step.

We have also determined that subjecting the set product to a step of pasteurisation has advantageous effects on the properties of the product.

In one aspect, the present invention provides a composition for the preparation of a confectionery product comprising 0.2 wt. % to 3 wt. % of at least one polysaccharide gelling agent, the balance being water.

Preferably, the at least one polysaccharide gelling agent is one or more of agar, pectin, locust bean gum, gellan gum, carrageenan, guar gum, konjac, glean gum, gum Arabic, Xanthan gum; alginate, arabinoxylan, arrowroot, carboxymethylcellulose, cassia gum, cellulose, curdlan, gellan, guar gum, gum Arabic, karaya gum, konjac, kuzu, marshmallow root, pectin, starch, xanthan gum and b-glucan.

Optionally, the composition further comprises gelatine in an amount of up to 1.5 wt. %.

Preferably, the at least one polysaccharide is at least one of agar, pectin, locust bean gum, gellan gum and carrageenan.

In one preferred embodiment, the at least one polysaccharide gelling agent is or comprises agar and a galactomannan polysaccharide.

Preferably, the composition comprises 0.5 wt. % to 2.00 wt. % agar and 0.05 to 1.0 wt. % of a galactomannan polysaccharide; the balance being water; preferably wherein the galactomannan polysaccharide is present in an amount of from 10% to 40% the amount of agar.

Preferably, the galactomannan polysaccharide has a mannose to galactose group ratio of about 4 groups of mannose to 1 group of galactose; preferably wherein the galactomannan polysaccharide is carob gum or locust bean gum.

Advantageously, the composition further comprises at least one electrolyte component in an amount of up to about 0.5 wt. %.; optionally wherein the at least one electrolyte component is one or more of sodium chloride, potassium chloride, disodium hydrogen citrate, potassium sulphate, calcium hydrogen phosphate, magnesium oxide, calcium carbonate, tricalcium phosphate and magnesium carbonate.

Optionally, the composition further comprises:

i) a non-nutritive sweetener; optionally wherein the non-nutritive sweetener is present in an amount of up to about 0.1 wt. %, preferably up to about 0.05 wt. %, more preferably about 0.025 wt. %; and/or

ii) at least one acidulant, optionally at least one of malic acid and citric acid, further optionally in an amount of up to about 1.0 wt. %; and/or

iii) up to about 5 wt. % of a starch or starch-derived polysaccharide, preferably about 1-3 wt. %., more preferably about 2 wt. %, optionally wherein the polysaccharide is maltodextrin.

Advantageously, the water content is at least 92 wt. %, preferably at least 94 wt. %.

Optionally, the composition further comprises at least one flavourant, preferably in an amount of up to about 0.5 wt. %, more preferably up to about 0.4 wt. %; and/or at least one colourant, preferably in an amount of up to about 0.5 wt. %, more preferably up to about 0.2 wt. %, more preferably up to about 0.15 wt. %.

The present invention also provides a confectionery product or hydration therapy product having or formed from a composition as defined above.

The present invention also provides a method of preparing an edible product, such as a confectionery product or hydration therapy product, the method comprising the steps of:

i) preparing a gelling agent composition comprising at least one polysaccharide gelling agent and optionally gelatine;

ii) adding the gelling agent composition to water in an amount of from about 1 wt. % to about 5 wt. %, preferably from about 1 wt. % to about 3 wt. %;

iii) heating the mixture in water to form a solution;

iv) heating the solution to a temperature above the activation temperature of the gelling agent composition;

v) cooling the solution to a temperature above the setting temperature of the gelling agent composition;

vi) depositing the solution; and vii) allowing the deposited solution to set to form a set confectionery product.

Preferably, the least one polysaccharide gelling agent is one or more of agar, pectin, locust bean gum, gellan gum, carrageenan, guar gum, konjac, glean gum, gum Arabic, Xanthan gum; alginate, arabinoxylan, arrowroot, carboxymethylcellulose, cassia gum, cellulose, curdlan, gellan, guar gum, gum Arabic, karaya gum, konjac, kuzu, marshmallow root, pectin, starch, xanthan gum and b-glucan.

Optionally, the gelling agent composition further comprises gelatine in an amount of up to 1.5 wt. %.

Preferably, the at least one polysaccharide is at least one of agar, pectin, locust bean gum, gellan gum and carrageenan.

Preferably, the gelling agent composition comprises 0.5 wt. % to 2.00 wt. % agar and 0.05 to 1.0 wt. % of a galactomannan polysaccharide; the balance being water; preferably wherein the galactomannan polysaccharide is present in an amount of from 10% to 40% the amount of agar.

Preferably, the galactomannan polysaccharide has a mannose to galactose group ratio of about 4 groups of mannose to 1 group of galactose; preferably wherein the galactomannan polysaccharide is carob gum or locust bean gum.

Preferably, the gelling composition is formed by mixing agar powder and a galactomannan polysaccharide powder in a ratio of from about 10 parts by weight of agar powder to about 1 to 4 parts galactomannan polysaccharide powder to form an agar-galactomannan polysaccharide mixture;

Preferably, the mixture obtained in step ii) comprises 0.5 wt. % to 2.00 wt. % agar and 0.05 to 1.0 wt. % galactomannan polysaccharide; the balance being water.

Advantageously, the gelling agent composition of step i) further comprises:

a) a non-nutritive sweetener; optionally wherein the non-nutritive sweetener is present in an amount of up to about 0.1 wt. % based on the total content of the mixture formed with water in step ii), preferably up to about 0.05 wt. %, more preferably about 0.025 wt. %; and/or

iii) a starch or starch-derived polysaccharide, preferably in an amount, based on the total content of the mixture formed with water in step ii) of up to about 5 wt. %, more preferably in an amount of about 1-3 wt. %., even more preferably about 2 wt. %, optionally wherein the polysaccharide is maltodextrin.

Preferably, the cooling step v) includes at least one intermediate step of:
a) cooling the solution to a first intermediate temperature and adding at least one electrolyte component in an amount of up to about 0.5 wt. %.; optionally wherein the at least one electrolyte component is sodium chloride and/or potassium chloride; optionally wherein the first intermediate temperature is about 80° C. and/or
b) cooling the solution to a second intermediate temperature, lower than the first intermediate temperature, and adding an acidic buffer mixture, optionally wherein the acidic buffer mixture comprises trisodium citrate and at least one of malic acid and citric acid, further optionally wherein the acidic buffer mixture is added in an amount of up to about 1.0 wt. %; yet further optionally wherein the second intermediate temperature is about 70° C.; and/or
c) adding at least one flavourant, preferably in an amount of up to about 0.5 wt. %, more preferably up to about 0.4 wt. %; and/or at least one colourant, preferably in an amount of up to about 0.5 wt. %, more preferably up to about 0.2 wt. %, more preferably up to about 0.15 wt. %.

In particular, the methods of the present invention can be characterised in that the method does not include a stoving or curing step.

Preferably, the method further comprises a step of pasteurising the set product.

The present invention further provides a method of enhancing the firmness of a gummy or jelly product, the method comprising a step of pasteurising the gummy or jelly product.

In a further aspect, the product is provided with at least one pocket of liquid within the body of the product. The or each pocket of liquid may be formed by injecting liquid into the composition at a time during its setting process at which the mixture is sufficiently viscous to encapsulate bubbles of the liquid but sufficiently fluid to deform to accommodate the additional volume of liquid without rupturing.

Suitably, the at least one pocket of liquid is introduced to the body of the product by injection through the body of the product. Alternatively, the at least one pocket of liquid is formed by adding one or more pellets of frozen liquid to the mixture prior to casting or moulding.

The above and other aspects of the present invention will now be described in further detail, by way of example only, with reference to the accompanying examples.

Except where the context indicates, all percentages are given as percentages by weight and, apart from references to water or ingredients which are inherently liquid at the relevant processing temperature, references are to percentages by weight of the dry ingredient.

The ingredients are all food-grade ingredients.

### Preparative Example 1

To make a 1000 g batch.

| Ingredients: | | |
|---|---|---|
| Hydrocolloid mixture | | |
| Agar (Gelidium) | 13 | g |
| Locust Bean Gum | 3.9 | g |
| Maltodextrin | 20 | g |
| Sucralose | 0.25 | g (to taste) |
| Electrolyte mixture | | |
| Sodium chloride | 0.84 | g |
| Potassium chloride | 0.72 | g |
| Potassium sorbate | 1 | g |
| Sodium benzoate | 0.88 | g |
| Acidic buffer mixture | | |
| Trisodium citrate | 1.4 | g |
| Malic acid | 3.8 | g (to taste) |
| Citric acid | 3.8 | g (to taste) |
| Flavouring | Up to 4 | g (as required) |
| Colouring | Up to 1.5 | g (as required) |

| | |
|---|---|
| Water | Balance |

The agar and locust bean gum powders were mixed to form a hydrocolloid mixture. A salt mixture was prepared containing the sodium chloride, potassium chloride, sodium benzoate and potassium sorbate. An acidic buffer mixture was prepared by mixing the trisodium citrate, malic acid and citric acid.

The hydrocolloid mixture was added, together with sucralose and maltodextrin, with sieving to 944.91g of water. The mixture was heated slowly, with stirring, to the activation temperature of the agar (100° C.). The mixture was boiled at this temperature for five minutes, with stirring, to activate the agar and locust bean gum.

The mixture was allowed to cool to around 80° C. (over a period of about 20 minutes). The salt mixture was added as a solution to the activated solution with thorough mixing.

The temperature of the solution was allowed to cool to about 70° C. and the acidic buffer mixture was added, with stirring. When agar is exposed to hot and acidic conditions, its gelling properties diminish. The acid buffer mixture counteracts this effect.

The colourings and flavourings are added to the mixture in the appropriate quantities to achieve the desired taste and colour; and at a temperature appropriate to the flavour and colour ingredients. Conveniently, powdered colourings and flavourings can be diluted with a small volume of water prior to addition, to improve uniform dispersion and reduce losses.

The mass of the mixture was weighed and water added as necessary to maintain the correct water percentage and total mass of the formulation.

Whilst the mixture remained at a temperature above the setting temperature of the agar (about 40° C. for Gelidium agar), the mixture was poured into moulds of the desired shape and the moulds were refrigerated until the moulded jellies were sufficiently stable to retain their moulded shape, typically after about 10 minutes at 4° C. for a moulded jelly, moulded as a teardrop shape, having a volume of about 13 ml and having a length of about 45 mm and a diameter at its maximum point of about 30 mm

As described above, in some embodiments, the product is provided with at least one pocket of liquid within the body of the product. Each pocket of liquid may be formed by injecting liquid into the composition at a time during its setting process at which the mixture is sufficiently viscous to encapsulate bubbles of the liquid but sufficiently fluid to deform to accommodate the additional volume of liquid without rupturing.

Suitably, the at least one pocket of liquid is introduced to the body of the product by injection through the body of the product. Alternatively, the at least one pocket of liquid is formed by adding one or more pellets of frozen liquid to the mixture prior to casting or moulding.

An advantage of providing localised pockets of liquid is that the resultant form releases small amounts of liquid when chewed. This is not enough to cause choking but wets the mouth to overcome dry mouth. Dry mouth decreases a person's ability to swallow and is particularly prevalent in people that have low fluid intake, such as those with reduced cognitive ability.

Pasteurisation

Significantly, from our research, we have found that subjecting the set product to a step of pasteurisation has advantageous effects on the properties of the product.

The set product was placed in a sealed tray and placed into a hot water bath such that the coldest part of the product is heated to an equivalent lethality of 70° C. for 5 minutes. For example, we pasteurised our set product by placing in a water bath at 75° C. for about 25 minutes. Other pasteurisation techniques, temperatures and durations are well known in the art and will be equally suitable for our process, including steam-jacketed ovens, microwave pasteurisers and so on.

Texture Analysis

Moulded jellies were subjected to texture analysis to analyse its textural parameters of firmness, springiness and bite force. Samples were analysed both prior to pasteurisation and post-pasteurisation.

A Stable Micro System TA XT Plus texture analyser fitted with a 5 kg load cell was used in compression mode. Fifteen individual pieces were measured for each sample.

The Full Compression test compressed the sample using a 25 mm diameter cylinder until the sample broke apart. The settings used were:

| Pre-test speed | 1 | mm/s |
|---|---|---|
| Test speed | 1 | mm/s |
| Post-test speed | 10 | mm/s |
| Strain | 60% | |
| Trigger force | 5 | g |

Firmness is defined, in this test, as the maximum peak force achieved in the test and Fracturability as the distance of this peak. Elasticity is calculated as the gradient of the trace between 5 mm and the Peak force. The force was also determined at 3 mm.

Texture Profile Analysis (TPA)

The Texture Profile Analysis is a double compression test used to calculate the springiness of a material. The texture profile is an important consideration for both our confectionery products and our hydration therapy products. For example, if the product is too flexible or frangible, it can be difficult to pick up, especially for people with limited dexterity. Accordingly, satisfactory firmness, factorability and elasticity are important considerations. Additionally, the product must be easy to chew and able to break apart and rupture easily in the mouth, with very little force or chewing, especially for people with weak jaw muscles and for those who may have lost some or all of their teeth. Yet, the products need to be able to withstand the production and packaging processes.

The samples were compressed using a 45 mm flat disk probe to 30% of its height (the strain). The settings used are shown below

| Pre-test speed | 5 | mm/s |
|---|---|---|
| Test speed | 5 | mm/s |
| Post-test speed | 5 | mm/s |
| Strain | 30% | |
| Trigger force | 5 | g |

Springiness is defined, in this test, as how much the sample springs back after the first compression (expressed a percentage of its height).

Bite Test

This test replicates the first bite into the sample by cutting the sample with a ‘tooth probe’.

The Bite force is defined, in this case, as the maximum force required to cut through the sample.

The settings used are shown below.

| Pre-test speed | 1 | mm/s |
|---|---|---|
| Test speed | 1 | mm/s |
| Post-test speed | 10 | mm/s |
| Strain | 60% | |
| Trigger force | 5 | g |

The results from all the texture analysis tests, with standard deviation values, are given in Table 1 below.

TABLE 1
Texture Analysis

| | Non-pasteurised | | Pasteurised | |
|---|---|---|---|---|
| Test | Value | SD | Value | SD |
| Firmness/g | 955 | 136 | 1502 | 83 |
| Fracturability/mm | 7.8 | 0.5 | 8.0 | 0.8 |
| Elasticity/g/mm | 209 | 24 | 329 | 44 |
| Bite Force/g (force) | 148 | 19 | 225 | 24 |
| Springiness | 93 | 3 | 96 | 4 |
| 3 mm Force | 120 | 14 | 175 | 57 |

As can be seen from these results, the additional step of pasteurising the set products gives rise to a very surprising increase in the firmness, elasticity and bite force of the product. This is particularly surprising bearing in mind the very high water content of the products.

Nutritional Analysis

The products, both prior to an post-pasteurisation, were subjected to nutritional analysis and the results, given per 100g, are given in Table 2 below:

TABLE 2
Nutritional Analysis

| | Non-pasteurised | | Pasteurised | |
|---|---|---|---|---|
| Energy | 61 | kJ/14 kcal | 67 | kJ/16 kcal |
| Fat | <0.1 | g | <0.1 | g |
| saturates | <0.1 | g | <0.1 | g |
| monounsaturates | <0.1 | g | <0.1 | g |
| polyunsaturates | <0.1 | g | <0.1 | g |
| trans | <0.1 | g | <0.1 | g |
| Carbohydrate (total) | 4.0 | g | 4.3 | g |
| Carbohydrate (available) | 3.0 | g | 3.5 | g |
| Sugars (total) | <0.1 | g | <0.1 | g |
| Dietary fibre | 1.0 | g | 0.8 | g |
| Protein (Kjeldahl) | <0.1 | g | <0.1 | g |
| Protein (Kjeldahl) N Factor | 6.25 | | 6.25 | |
| Moisture | 95.1 | g | 95.1 | g |
| Ash at 525° C. | 0.81 | g | 0.56 | g |

Surprisingly, the increase in the firmness, elasticity and bite force of the product evidenced in Table 1 is not at the cost of a decrease in water content. As can be seen from Table 2, the water content of the tested products remained the same both pre- and post-pasteurisation.

### Preparative Example 2

Ingredients

| | | |
|---|---|---|
| Water | 100 | ml |
| Agar | 2 | g |
| Carrageenan | 1 | g |
| Locust Bean Gum | 0.3 | g |
| Sodium Citrate (as electrolyte) | 0.2 | g |
| Citric Acid (as preservative) | 0.3 | g |
| Sweeteners: | | |
| Sucralose | 0.06 | g; or |
| Stevia | 0.15 | g; |
| Aspartame-based sugar | 2 | g |
| replacement | | |
| Sugar (sucrose) | 5 | g |

| | |
|---|---|
| Flavourings | 2 drops (concentrated strawberry |
| | flavouring) |
| Colouring | 10 drops (red food colouring) |

All the powdered ingredients were added slowly, with slow stirring, to the water, warmed to about 50° C. The mixture was then heated to 70-80° C. until all the powders had dissolved. The flavourings and colouring were then added and thoroughly mixed to give a mixture having a viscosity of 1,000-5,000 centipoise (1-5 Pa.s) making it suitable for use with standard industrial food production injection machinery.

The mixture was injected into moulds to form a three-dimensional shape, such as that of a teardrop. The mixture was then cooled to reduce its setting time. Cooling at 4° C. resulted in a setting time of 15 minutes and cooling at −11° C. gave a setting time of 9 minutes.

Variations

The procedures outlined above were also followed to prepare products using the following mixtures of gelling agents. The example percentages given are percentages by weight based on the combined weight of all dry and fluid components in the solution prior to moulding or depositing.
i) Gelatine (1.38 wt. %) and Agar (0.83 wt./%)
ii) Agar (1.4 wt. %) and Pectin (0.47 wt. %)
iii) Agar (1.4 wt. %), Pectin (0.47 wt. %) and Locust bean gum (0.9 wt. %)

iv) Gellan gum (0.25 wt. %)
v) Carageenan (1.5 wt. %)
vi) Gellan gum (1.5 wt. %) and Locust bean gum (0.75 wt. %)

All the above combinations gave excellent quality products having good firmness for picking up by hand and an appealing texture.

All or some of the water in the above recipes may be replaced by other drinkable water-based liquids, such as fruit juices, milk or a cereal, vegetable or nut milk.

Whilst the present invention has been devised particularly to provide a high water content product for the purposes of hydration therapies, it will be appreciated from the above discussion that the compositions and methods are equally applicable to the manufacture of confectionery. In the field of confectionery, water contents of the order of 90 wt. % or more may not be required. In other words, it may not be necessary to replace all of the bulk sweetener of a typical confectionery product with water. Accordingly, particularly in the field of gummy and jelly confectionery, water contents of 20 wt. % or more may, for certain products, be chosen. Preferably, the water content of a confectionery product in accordance with the present invention is at least 25 wt. % or more, 40 wt. % or more, 50 wt. % or more, 60 wt. % or more or 70 wt. % or more. Most preferably, a confectionery product in accordance with the present invention comprises at least about 80 wt. % water (or other water-based beverage).

Hydration Therapy

As described in detail above, an objective of the present invention is to provide a product suitable for use as a hydration therapy, particularly, but not exclusively, for people with dementia. It is advantageous for this purpose to present the products of the present invention in a format which can attract the person's attention to the product and make it easy to use. We have found forming the products into ‘bite sized’, teardrop-shaped products have been particularly successful.

An advantage of the above described system is that the resulting solid hydrating matrix is engaged with more often. When presented in this format, consuming the solid hydrating matrix can be more enjoyable. This is especially the case for people with reduced cognitive ability that may otherwise struggle to stay hydrated using more traditional means.

Another advantage of presenting the product in a teardrop shape is that it makes it easier to use. The teardrop can be presented in a way that allows for it to be easily picked up from a supporting tray. This is beneficial for people with limited dexterity, poor sight and reduced grip and/or coordination.

A further advantage of presenting the liquid in a solid matrix in a ‘bite size’ format is that it encourages behaviour which means they eat ‘little and often’. This allows the body time to process the fluids from them efficiently, therefore resulting in optimal hydration.

Another advantage of presenting the liquid in a solid matrix in a discrete format allows for easier assessment of how much has been eaten. This makes it easier for carers to assess how much fluid the person has ingested and, from that, confidently confirm adequate hydration.

The products may be mixed with additives that improve the rate and amount of fluid absorbed e.g. electrolytes or carbohydrates; or with nutritional components such as vitamins and minerals.

An advantage of the above described system is that maximal hydration can be delivered. It optimises the amount of fluid absorbed. The system reduces the amount of liquid in a solid matrix that needs to be ingested. This is beneficial in circumstances where the amount of food eaten is restricted. It is also beneficial as it reduces the urine output, a factor that can deter some people from taking sufficient water through normal drinking.

The present invention provides a gummy and jelly formulation in which the conventional bulk sweetener bulking agent is effectively replaced entirely by water as the bulking agent, giving a high water content confection. The composition provides a sugar-free confection without relying on polyols or other bulk sweeteners having negative gastrointestinal effects.

We have also surprisingly determined that the composition can be deposited into a firm product which is easy to pick up without the need for a time-consuming stoving process.

We have also determined that products of the present invention can be subjected to a pasteurisation step without any detrimental impact on the shaping of the product. Furthermore, pasteurisation has a surprising enhancing effect the physical properties of the product.

Consequently, the present invention provides gummy and jelly products and methods for the production of gummy and jelly products which avoid the need for a curing or stoving process and which can be subjected to a pasteurisation step, whilst producing a product which is sufficiently firm, even when moulded to a relatively large size, to be held by hand. The present invention is all the more surprising in that such a product can be produced which has a water content of up to about 95 wt. % or higher.

1. A composition for the preparation of an edible product, the composition comprising 0.2 wt. % to 3 wt. % of at least one polysaccharide gelling agent, the balance being water.

2. A composition as claimed in claim 1 wherein the at least one polysaccharide gelling agent is one or more of agar, pectin, locust bean gum, gellan gum, carrageenan, guar gum, konjac, glean gum, gum Arabic, Xanthan gum; alginate, arabinoxylan, arrowroot, carboxymethylcellulose, cassia gum, cellulose, curdlan, gellan, guar gum, gum Arabic, karaya gum, konjac, kuzu, marshmallow root, pectin, starch, xanthan gum and b-glucan.

3. A composition as claimed in claim 1 or claim 2 further comprising gelatine in an amount of up to 1.5 wt. %.

4. A composition as claimed in any preceding claim wherein the at least one polysaccharide is at least one of agar, pectin, locust bean gum, gellan gum and carrageenan.

5. A composition as claimed in any preceding claim comprising 0.5 wt. % to 2.00 wt. % agar and 0.05 to 1.0 wt. % of a galactomannan polysaccharide; the balance being water; preferably wherein the galactomannan polysaccharide is present in an amount of from 10% to 40% the amount of agar.

6. A composition as claimed in claim 5 wherein the galactomannan polysaccharide has a mannose to galactose group ratio of about 4 groups of mannose to 1 group of galactose; preferably wherein the galactomannan polysaccharide is carob gum or locust bean gum.

7. A composition as claimed in any preceding claim further comprising at least one electrolyte component in an amount of up to about 0.5 wt. %.; optionally wherein the at least one electrolyte component is at least one of sodium chloride, potassium chloride disodium hydrogen citrate, potassium sulphate, calcium hydrogen phosphate, magnesium oxide, calcium carbonate, tricalcium phosphate and magnesium carbonate.

8. A composition as claimed in any preceding claim further comprising:
i) a non-nutritive sweetener; optionally wherein the non-nutritive sweetener is present in an amount of up to about 0.1 wt. %, preferably up to about 0.05 wt. %, more preferably about 0.025 wt. %; and/or
ii) one or more nutrient compositions, optionally one or more vitamins, minerals, fats or amino acids; and/or
iii) at least one acidulant, optionally at least one of malic acid and citric acid, further optionally in an amount of up to about 1.0 wt. %; and/or
iv) up to about 5 wt. % of a starch or starch-derived polysaccharide, preferably about 1-3 wt. %., more preferably about 2 wt. %, optionally wherein the polysaccharide is ma ltodextrin.

9. A composition as claimed in any preceding claim wherein the water content is at least 92 wt. %, preferably at least 94 wt. %.

10. A composition as claimed in any preceding claim further comprising at least one flavourant, preferably in an amount of up to about 0.5 wt. %, more preferably up to about 0.4 wt. %; and/or at least one colourant, preferably in an amount of up to about 0.5 wt. %, more preferably up to about 0.2 wt. %, more preferably up to about 0.15 wt. %.

11. A composition as claimed in any preceding claim wherein the composition is a sugar-free composition and/or contains no components having laxative effects.

12. A confectionery product or hydration therapy product having or formed from a composition as claimed in any preceding claim.

13. A product as claimed in claim 12 further comprising at least one pocket of liquid within the product.

14. A method of preparing an edible product, the method comprising the steps of:
i) preparing a gelling agent composition comprising at least one polysaccharide gelling agent and optionally gelatine;
ii) adding the gelling agent composition to water in an amount of from about 1 wt. % to about 5 wt. %, preferably from about 1 wt. % to about 3 wt. %;
iii) heating the mixture in water to form a solution;
iv) heating the solution to a temperature above the activation temperature of the agar;
v) cooling the solution to a temperature above the setting temperature of agar;
vi) depositing the solution; and
vii) allowing the deposited solution to set to form a set confectionery product.

15. A method as claimed in claim 14 wherein the least one polysaccharide gelling agent is one or more of agar, pectin, locust bean gum, gellan gum, carrageenan, guar gum, konjac, glean gum, gum Arabic, Xanthan gum; alginate, arabinoxylan, arrowroot, carboxymethylcellulose, cassia gum, cellulose, curdlan, gellan, guar gum, gum Arabic, karaya gum, konjac, kuzu, marshmallow root, pectin, starch, xanthan gum and b-glucan.

16. A method as claimed in claim 14 or 15 further comprising gelatine in an amount of up to 1.5 wt. %.

17. A method as claimed in any one of claims 14 to 16 wherein the at least one polysaccharide is at least one of agar, pectin, locust bean gum, gellan gum and carrageenan.

18. A method as claimed in any one of claims 14 to 17 wherein the gelling agent composition comprises 0.5 wt. % to 2.00 wt. % agar and 0.05 to 1.0 wt. % of a galactomannan polysaccharide; the balance being water; preferably wherein the galactomannan polysaccharide is present in an amount of from 10% to 40% the amount of agar.

19. A method as claimed in claim 18 wherein the galactomannan polysaccharide has a mannose to galactose group ratio of about four groups of mannose to one group of galactose; preferably wherein the galactomannan polysaccharide is carob gum or locust bean gum.

20. A method as claimed in any one of claims 14 to 19 wherein the gelling composition is formed by mixing agar powder and a galactomannan polysaccharide powder in a ratio of from about 10 parts by weight of agar powder to about 1 to 4 parts by weight of a galactomannan polysaccharide to form an agar-galactomannan polysaccharide mixture;

21. A method as claimed in any one of claims 14 to 20 wherein the mixture obtained in step ii) comprises 0.5 wt. % to 2.00 wt. % agar and 0.05 to 1.0 wt. % galactomannan polysaccharide; the balance being water.

22. A method as claimed in any one of claims 14 to 21 wherein the gelling agent composition of step i) further comprises:
a) a non-nutritive sweetener; optionally wherein the non-nutritive sweetener is present in an amount of up to about 0.1 wt. % based on the total content of the mixture formed with water in step ii), preferably up to about 0.05 wt. %, more preferably about 0.025 wt. %; and/or
iii) a starch or starch-derived polysaccharide, preferably in an amount, based on the total content of the mixture formed with water in step ii) of up to about 5 wt. %, more preferably in an amount of about 1-3 wt. %., even more preferably about 2 wt. %, optionally wherein the polysaccharide is maltodextrin.

23. A method as claimed in any one of claims 14 to 22 wherein cooling step v) includes at least one intermediate step of:
a) cooling the solution to a first intermediate temperature and adding at least one electrolyte component in an amount of up to about 0.5 wt. %.; optionally wherein the at least one electrolyte component is sodium chloride and/or potassium chloride; optionally wherein the first intermediate temperature is about 80° C. and/or
b) cooling the solution to a second intermediate temperature, lower than the first intermediate temperature, and adding an acidic buffer mixture, optionally wherein the acidic buffer mixture comprises trisodium citrate and at least one of malic acid and citric acid, further optionally wherein the acidic buffer mixture is added in an amount of up to about 1.0 wt. %; yet further optionally wherein the second intermediate temperature is about 70° C.; and/or
c) adding at least one flavourant, preferably in an amount of up to about 0.5 wt. %, more preferably up to about 0.4 wt. %; and/or at least one colourant, preferably in an amount of up to about 0.5 wt. %, more preferably up to about 0.2 wt. %, more preferably up to about 0.15 wt. %.

24. A method as claimed in any one of claims 14 to 23 characterised in that the method does not include a stoving or curing step.

25. A method as claimed in any one of claims 14 to 24 further comprising a step of pasteurising the set confectionery product.

26. A method as claimed in any one of claims 14 to 25 further comprising forming at least one pocket of liquid in the set product, optionally by injecting liquid into the composition at a time during its setting process at which the mixture is sufficiently viscous to encapsulate bubbles of the liquid but sufficiently fluid to deform to accommodate the additional volume of liquid without rupturing; or by adding one or more pellets of frozen liquid to the mixture prior to casting or moulding.

27. A method of enhancing the firmness of a gummy or jelly product, the method comprising a step of pasteurising the gummy or jelly product.

28. A method as claimed in claim 27 wherein the gummy or jelly product is a product as claimed in claim 12 or claim 13 or obtainable by a process of any one of claims 14 to 27.
